(19) United States
(12) Patent Application Publication
(10) Pub. No.: US 2006/0218225 A1
(43) Pub. Date: Sep. 28, 2006

(54) Device for sharing social network information among users over a network

(76) Inventors: George Hian Hee Voon, San Jose, CA (US); Vijoy Anand Pandey, San Jose, CA (US)

Correspondence Address: COURTNEY STANIFORD & GREGORY LLP, P.O. BOX 9686, SAN JOSE, CA, 95157, US

(21) Appl. No.: 11/392,314

(22) Filed: Mar. 28, 2006

Related U.S. Application Data
(60) Provisional application No. 60/666,318, filed on Mar. 28, 2005.

(51) Int. Cl. G06F 15/16

(52) U.S. Cl. 709/201

(57) ABSTRACT

Embodiments for a communications device for implementing social network interactivity are described. A device according to embodiments comprises a communications interface for communicating with one or more peer devices over a network, a data store for storing data relevant to an interest of a user of the device and identification information for respective users of the one or more peer devices, a content manager circuit configured to store data on the device based on the interest of the user and browse content stored on the one or more peer devices, and an interest manager circuit configured to group the respective users into one or more interest groups and assign access rights to the respective users of the one or more peer devices.

### CROSS-REFERENCE TO RELATED APPLICATIONS

The current application claims the benefit of U.S. Provisional Patent Application 60/666,318, filed Mar. 28, 2005. The current application is related to U.S. patent application entitled “Building Social Networks Using Shared Content Data Relating to a Common Interest” filed on Mar. 28, 2006.

### FIELD

Embodiments of the invention relate generally to portable network devices, and more specifically, to a device for sharing social network information including interest and content data with a plurality of users.

### BACKGROUND

Every person goes through the process of making literally tens to hundreds of decisions everyday over the course of their entire life for the smallest to the most critical aspects of daily living, such as selecting a simple product in a grocery store, delving into a new hobby, making a new career move, or deciding on a new life partner. Except for snap decisions, every event, big or small, is typically preceded by a decision process cycle. Through this process, an individual usually elicits opinions and advice from peers and experts in the subject, compiles all the information obtained from the others or researched himself, and finally makes a decision or takes an action. Although the decisions people make in life are ultimately their own, the decision making process often involves input or reliance on other people, such as family, friends, experts, and so on. In fact, most important decisions rely heavily on input and recommendations from “people who know,” and this set of people can range from professional critics and advisers, to acquaintances who have a deeper understanding of the factors that affect the decision.

FIG. 1 illustrates a typical manual decision making process that a person might go through to make a decision. Based on a particular objective 102, a person typically formulates a question and then queries anyone who might know (consultants) or help make the best decision, 104. The feedback from these people represents information datapoints that the person uses as influence, opinions, or advice 106 toward the ultimate decision or action 108. Depending upon the expertise of the consultants 104, their influence may be weighted by a bias factor, thus, influence may be amplified if the consultant is an expert or downplayed if he is a novice. Ultimately, the advice 106 may be used to form a decision or take an action 108. As shown in FIG. 1, in typical decision making processes, the input from other people is often crucial in reaching a particular decision.

Although everybody has different ways of making decisions, the steps of identifying consultants, gathering information data points, and quantifying trust factors are often done in an ad hoc manner that can require a great deal of effort, yet still not achieve an optimum result. Although the rise of computerized networks and mobile communications has made it easier for people to build social networks, communicate, find resources and download information, such networks have not yet truly facilitated the decision making process. Although people can generally find information more readily using the Internet, and quickly contact friends and family over modern telecommunications networks, the process of making decisions typically still involves manually identifying consultants, making the query and then gathering the individual data points to formulate a decision. Such a process may involve querying many people on an individual basis, gathering their individual opinions and then reaching a decision based on a mental compilation of the various opinions. Present communications systems may help in reaching these people quickly and easily, but do not actually facilitate the decision making process.

What is needed, therefore, is a means to request the assistance of anyone within a person's network who would be able to help make a decision by automatically and easily building a database of consultants who know about a particular subject, and retaining the advice, opinions and influences that a user obtains in response to a query. What is further needed is a means to transparently and effortlessly gather and share data that has been gathered over time among users of a network so that such data can be used in each user's decision making processes. Comprehensively, these mechanisms as a whole would give an individual the power he or she needs to make the optimum decision, execute more efficiently, and ultimately, become more productive. Such a tool would help a person automatically and easily build a network of consultants on particular topics, borrow their influences and opinions on demand, and gather the required information data points transparently from these contacts without excessive disruption.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a typical manual (prior art) decision making process that a person might go through to make a decision.

FIG. 2A diagrammatically illustrates the definition of a social network used in embodiments of the present invention.

FIG. 2B illustrates the components of a social network used in embodiments of the present invention.

FIG. 3 illustrates a decision making process implemented by a system according to an embodiment.

FIG. 4 illustrates a network system that implements one or more embodiments.

FIG. 5 illustrates the network states for a Socializer device, according to an embodiment.

FIG. 6 illustrates the main functional components of the Socializer, under an embodiment.

FIG. 7 is a diagram that illustrates the functional components and process flows for the content manager portion of the Socializer, under an embodiment.

FIG. 8 illustrates a flow process for the interest manager portion of the Socializer under an embodiment.

FIG. 9 illustrates a flow process for the security panel portion of the Socializer under an embodiment.

FIG. 10 is a diagram that illustrates the functional components and process flows for the contact manager portion of the Socializer under an embodiment.

FIG. 11 illustrates network components for networked Socializer devices, under an embodiment.

FIG. 12 is a flowchart that illustrates a method of defining a social network and formulating a decision based on the social network, according to an embodiment.

### DETAILED DESCRIPTION

Embodiments of a system for building social networks and information databases for use in decision making and other social activities are described. In the following description, numerous specific details are introduced to provide a thorough understanding of, and enabling description for, embodiments of a decision making device and process. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

A device according to embodiments comprises a communications interface for communicating with one or more peer devices over a network, a data store for storing data relevant to an interest of a user of the device and identification information for respective users of the one or more peer devices, a content manager circuit configured to store data in the device based on the interest of the user and browse content stored on the one or more peer devices, and an interest manager circuit configured to group the respective users into one or more interest groups and assign access rights to the respective users of the one or more peer devices.

A method according to embodiments comprises defining an interest for a user, loading content relating to the interest in a computing device operated by the user, identifying other users within a network of the user to define the interest group, defining access privileges for the other users with respect to the content on the computing device; and obtaining non-content data from the other users to make one or more decisions related to the interest, wherein the non-content data comprises opinion information of a consultant weighted by a bias value, and wherein the bias value depends on the expertise of the consultant, and wherein the access privileges depend in part on the relationship between the user the consultant.

Social Networking

Embodiments are directed to a computer-implemented process that facilitates the building of social networks and information databases for communications over a peer-to-peer network platform. The definition of a person's social network generally determines the resources available to that person during a decision making process and the extent to which the person must communicate to gather the desired information. A social network describes a set of human connections that represent a map of the relationships between individuals, indicating the ways in which they are connected through various social familiarities ranging from casual acquaintance to close familial bonds. Individuals form the nodes of the network, and the connections/ties are the relationships between the individuals. The three most popular measures for the studying the characteristics of a social network are (1) Closeness, (2) Degree, and (3) Betweenness. Closeness measures how quickly (number of hops) the individual can reach any other member of the network; degree is the number of direct connections a node has on the social network; and betweenness measures how important the individual is in maintaining the relationship between two different nodes.

The closeness measure is exemplified by a metric often referred to as an “Erdos number,” which was named after Paul Erdos, a famous graph theorist of the 20^{th} century. The Erdos number refers to the one's associative proximity to Erdos himself, so a person who knew Erdos directly would have an Erdos number of one, and a person who knew someone who knew Erdos would have an Erdos number of two, and so on. This measure is typified by the popular concept referred to as the “Six Degrees of Separation,” which postulates that there are only six hops between any two people on the planet. Closeness only provides an indication of nodal distance between any two people, and degree measures how many direct contacts a person has, but neither captures the quality of the links. The concept of betweenness tries to capture the importance of the people to one another. Thus, although two people may be directly linked to Erdos, a principle collaborator may have a stronger link to Erdos than a person who casually knew Erdos.

In general, the shape of the social network has been found to be a key factor in a network's usefulness to the individuals it includes. Tighter networks, for example, are oftentimes actually less useful to their members than networks with lots of empty spaces (social holes) or loose connections to other individuals outside the main network (weak ties). Generally open networks with many weak ties and social holes, are more likely to introduce new ideas and opportunities to their members than closed networks with many redundant ties. A group of individuals where each has connections to other social worlds is likely to have access to a wider range of information. Therefore, it has been shown that it is better for individual success to have connections to a variety of networks rather than many connections within a single network.

Embodiments of a contact and interest sharing platform for decision making processes that implement theories of social networks and social behavior, as well as new concepts that enable implementation of communication mechanisms that facilitate secure and manageable access to information among many users in different distributed network structures are disclosed herein. In one embodiment, the social network platform comprises the basic components of people, interest, bias, and trust. People are the building blocks of all social networks, and degree is an implicit attribute of an individual in the social network. The social network of a person can consist of many different people (contacts). Some people comprise long-term or close friends or relatives of the person, while others might be short-term or temporary acquaintances. These contacts may be objectified and stored in the social network database in different ways. Thus, for a typical active network, the contacts can consist of individuals stored in a static contact list (such as an address book), as well as individuals that dynamically connect to the network at any given time. Any individual can be a member of multiple social networks, and these social networks can be defined for many different activities, such as interests, residence, occupation, and so on. For example, person who is both an architect and a stamp collector can be associated with two distinct and identifiable interest groups, each composed of very different groups of people.

Different contacts in a person's social network may have different degrees of influence over the person. This is reflected in the “betweenness” of the two individuals. The two most critical characteristics of betweenness are trust and bias (prejudice), as far as the individual is concerned. In general, access to information is controlled by the trust that the individuals have for each other. Using the example of Paul Erdos, assume that colleagues of his named Goodman, Burr and Harary all had Erdos Numbers of 1. If Harary was a more trustworthy friend of Erdos, while Burr had more knowledge of directed graphs, and Goodman was just a professional acquaintance, there might be two aspects of betweenness as follows: Erdos would have greater trust in Harary, compared to Goodman and Burr, and would be willing to share most of his unpublished papers and ideas with Harary. If Erdos had questions on directed graphs, he would value Burr's opinion over Harary, and might not even consider bringing Goodman into the picture. Hence, an opinion is almost always weighted by bias, with respect to the individual's perceived expertise within the interest group. These novel concepts of bias and trust generally do not appear in the theory of social networking, but they practically capture the essence of betweenness.

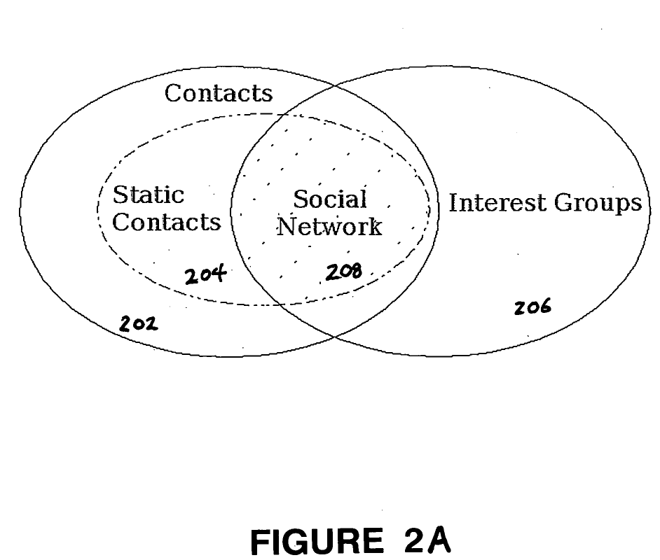

Closeness is a network-wide attribute, and is more of a tool for social network analysis, and therefore, a practical implementation does not necessarily need to define or configure this attribute on a per-individual basis. On the other hand, closeness is a useful statistic to view in the context of the entire network. FIG. 2A diagrammatically illustrates the definition of a social network used in embodiments of the present invention. In FIG. 2A, the contacts group (C) 202 is the set of all contacts for an individual and can be composed of static contacts (pre-known) 204 as well as dynamic contacts (formed at any given instant). Interest groups (I) 206 represent the set of all possible interest groups for a user. If T is the set of all trust levels that an individual can define for all contacts, and B denotes the set of biases that the individual could place on his contacts' opinion on any subject matter, then a social network (snₛ) 208 can be defined as:
snₛ=cₛ∩iₛ
where cₛ is a subset of C, and iₛ is a subset of I. That is, the intersection between contacts (people) and interest groups is defined as a social network 208. The attribute that governs the access of information is denoted tₛ, which is a subset of T, and the attribute that governs the significance of an opinion or influence is denoted bₛ, which is a subset of B. In the context of a decision making process, the social network 208 defines the people whom the person uses as consultants or information resources with respect to a particular interest, and the trust and bias metrics represent the influences that lead to a decision.

FIG. 2B illustrates the components of a social network used in embodiments of the present invention. Generally speaking, a social network consists of people linked to one another by a particular interest or purpose. For the embodiment illustrated FIG. 2B, the social network 220, which consists of people 221 and interests 223 organized to form “interest groups,” creates and/or uses social network information 222. Thus, the term “social network” refers to a particular interest along with a group of people.

The interest defining a social network could consist of subject matter for any topic (e.g., music), or it could be a sub-topic or genre within a particular type of subject matter (e.g., rock music), or it could be an even narrower categorization of topic. Thus, in general, interest can be defined as any topic at any level of scope. The interest of the social network generally defines the information 222 used by the network. Thus, for example, if the social network illustrated in FIG. 2B is a group of people interested in 1960's rock music, the information 222 would 1960's rock songs, bands, concerts, and so on. The content data 224 for this social network might be actual songs or records from this era, and the non-content data 226 would be information about the members of the interest group, metadata about the content data objects (i.e., the song files), and similar defining information.

People within an interest group may be referred to as “members” of that group. The social network information 222 represents all of the information, content, data, and so on that defines the network, members and the interest itself. The social network information is divided into two main types of data: content data 224 that comprises the actual data embodying or interest, and non-content data 226 that comprises information about the content data, network, members and so on.

In one embodiment, the content data is stored and processed in the form of data objects, and the non-content data comprises metadata describing the data objects, as well as information relating to the network and members. Metadata typically refers to information about content or data objects, and in relation to embodiments described herein refers to characteristics about the data objects, as well as information related to the members and the interest. The content data and non-content data that make up the social network information may be data that is derived from people or resources outside of the social network, or generated by members of the social network, or produced by processes used to manage the social network and interactions among the members. For example, processes that define and manage the content data objects may automatically define the non-content meta-data for the content, while content data (e.g., pictures or songs) related to the interest may be imported into the network by a member.

In one embodiment, metadata are the attributes of the content, interest groups and contacts. For content, the metadata includes the title of the content (e.g., song name, video name, photograph ID), information about the kind of content (e.g., music, video, photograph), information about encoding (e.g., MP3, MPEG-4, JPEG), information about its placement or ranking in its interest group (e.g., song #1 in the album The Wall, from artist Pink Floyd, in the sub-genre Rock Music, in Music; Clip #2 in the movie The Terminator, in the sub-genre Sci-Fi, in Movies, photo #5 in the photo-album Yosemite, in the sub-genre landscape photography, in Photography, and any other relevant descriptors of the content. For interest groups, the metadata includes title of the interest group (e.g., Photography, Landscape Photography, Rock Music), keywords and descriptions about the interest group (e.g., terms, phrases and paragraphs to define “Landscape Photography”), information about the trust level for this interest group (e.g., Jim can view only meta-data in Photography; John can access all content in Photography), information about bias and recommendation for the content in this interest group (e.g., value John's opinion more in Music over Jim's), and any other relevant descriptors of the interest group. For contacts, the metadata includes the unique ID information, including IP addresses, name and communication addresses, including VoIP addresses, email addresses, instant messaging addresses, alert IDs, phone numbers, and postal addresses, trust levels for the contacts over every interest group (e.g., Jim can view meta data for Photography, Jim can view all content in Video), bias information for each contact over every interest group (e.g., value John's opinion most in Music, value John's opinion least in Movies), and any other relevant descriptors of the contacts. Metadata is used to facilitate the organization, storage, and accessibility of the content data used by each member, and to help define social networks within a member's neighborhood.

Social Networking Device

In one embodiment, social networking principles are incorporated in a computer implemented device or program that assists an individual in making decisions more effectively, easily, and efficiently. The social networking process, referred to herein as the “Socializer” simplifies the entire decision making process for an individual by tapping into the resources of his social network and allowing him to execute towards his goals more diligently. The Socializer can either be a software program or module running on a computer participating in a wired or wireless (both organized and infrastructure-less/ad-hoc) network, or it can be a hardware device running the software functionality and participating in a wired or wireless (organized or infrastructure-less/ad-hoc) wireless network for providing true anytime, anywhere effectiveness to the decision process. Throughout this document, the terms Socializer, entity, mechanism, and node are used interchangeably.

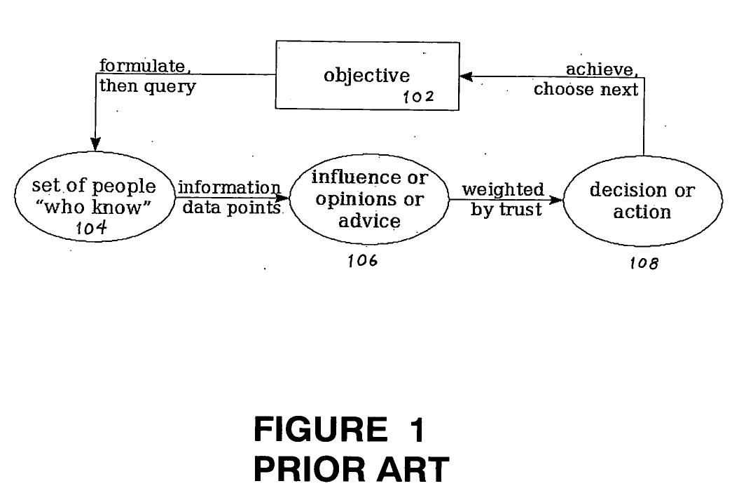

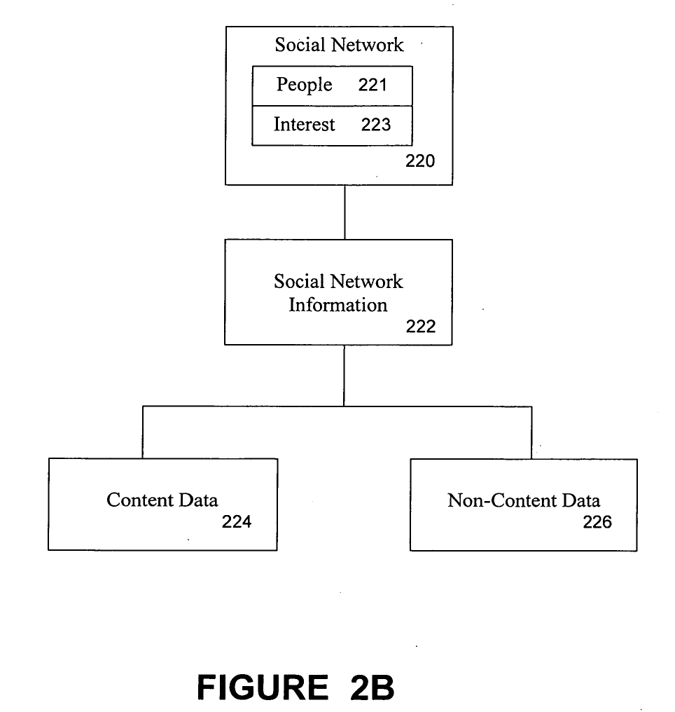

Using the basic model of the decision making process illustrated in FIG. 1, the decision making process implemented by the Socializer incorporates information related to the interest group, as illustrated in FIG. 3. Thus, the objective 302 to be obtained is one that is specifically defined in the context of the social network, such as meeting people within the network or sharing information with people that have the same interest (reside in the same interest group). As shown in FIG. 3, once an objective in the context of the social network 302 is formulated, “people who know” 304 are consulted. These people are those who the individual thinks are experts for that interest. As illustrated in FIG. 3, the set of “people who know” 304 comprise the static or dynamic contacts within the interest group or groups for the person. The Socializer creates and maintains crisp definitions of the various interest groups (iₛ) of the individual. The interest groups can change depending upon the objective 302, or the decision 310 to be made.

In one embodiment, the Socializer includes mechanisms to grow and maintain the set of contacts (cₛ) of the individual with transparent ease. Since all contacts are not equally trusted with respect to the content within the context of an interest group, means must be provided to allow or disallow various types of access to the content within each interest group. For example, a person may allow some people within his interest group to view entries in his address book, but not others. The access controls can be based on the value of the content as well as the trust that the user has on various individuals in his social network. Moreover, individuals in the Socializer user's social network should be able to access this content passively. In other words, the Socializer provides a non-invasive method to gather the information the individual needs from the various contacts, if possible and if allowed, based on the trust level (tₛ) of the individual with respect to the content in an interest group.

In one embodiment, the Socializer assigns a relative importance to the advice or opinion 306 the user receives relating to the content in any interest group. For example, the user might place a higher weight on the advice he receives from a colleague with regard to a work related decision, versus advice received from friends. Once the user has gathered all the opinions, information and recommendations needed, the Socializer assigns a weight to these influences, based on the bias (b₅) that the user places on each contact for the content in an interest group. This is illustrated in FIG. 3, as the bias factor 308. This bias can be absorbed in three different ways: messages, which translate to advice or influence, can be bias weighted and viewed; content within other users' interest groups can be accessed weighted by bias, hence translating to a better influence; and content within an interest group can be opinion tagged by others in the social network. In general, opinions themselves are not enough to provide influence. Therefore, the user should be able to accumulate all opinions about content in the interest group weighted by the bias of the opinion giver, into an index, which is referred to as a “recommendation.” The recommendation measure (rₛ) can be defined as:
rₛ=oₛ×b₅
where O is the set of all opinions and oₛ is a subset of O.
Socializer Implementation

In one embodiment, the Socializer is implemented as a software program running on a computer coupled to a wired or wireless network. Alternatively, the Socializer can be implemented as a hardware device executing firmware or software instructions to perform the methodologies described herein. Regardless of the implementation platform, the Socializer comprises the main layers of application software, support software, and, to the extent necessary, underlying hardware or hardware interface components.

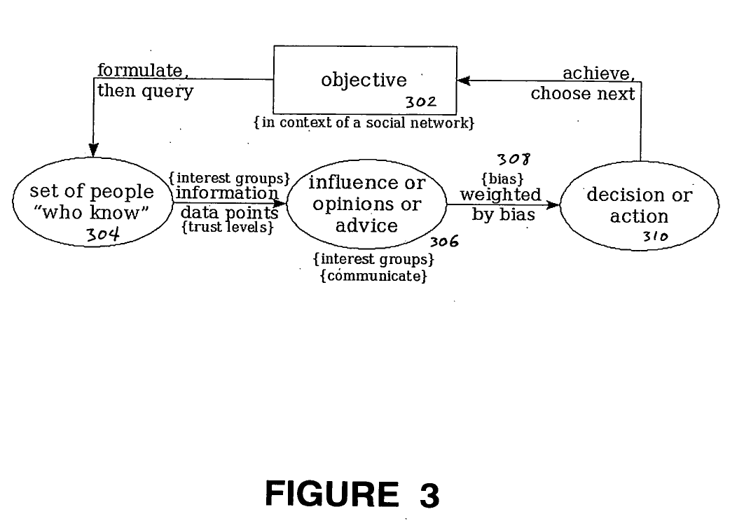

As stated above, aspects of the one or more embodiments described herein may be implemented on one or more computers or computing devices executing software instructions. The computers and/or computing devices may be networked in a client-server arrangement, peer-to-peer network, or similar distributed computer network, and may comprise personal computers, workstations, laptop computers, server computers, or any standalone computing device. The communication means employed by the networked computing devices may be wired, wireless, single-hop, multi-hop, broadcast or any combination thereof. FIG. 4 illustrates a network system 400 that implements one or more embodiments. In system 400, a computer 404 executing a Socializer software module 405 is coupled over network 410 to one or more other computers 406 running their respective Socializer modules 407. Network 410 may be the Internet, a Wide Area Network (WAN), a Local Area Network (LAN), or any combination thereof. In one embodiment, the Socializer module 405 or 407 executed by computers 404 and 406 may represent one or more executable programs modules that are stored within the respective computers and executed locally within the computer. Alternatively, the modules may be stored on a remote storage or processing device coupled to the computers or network 410 and accessed by computers to be locally executed.

The Socializer process may also be embodied within a computing device, such as a portable computing device 402 or 408. The portable computing device may be a personal digital assistant (PDA), small notebook computer, portable game device, enhanced cellular phone, or similar mobile computing device that contains adequate processing, storage, display, and communications capability. For the embodiment in which the Socializer process is embodied within a portable computing device, such as 402 or 408, the executable modules comprising the Socializer can be integrated closely with the hardware, such as through firmware or programmed logic circuits, or they may be implemented as software modules executed by the processing unit of the device. The portable device embodying the Socializer may include computer interface or docking tools that allow the user to synchronize the Socializer with a home computer, and communicate or store data using the resources of the computer.

One or more of the Socializer devices within network 400 may be configured to communicate with other devices in the network over alternative or additional network links. For example, portable devices 402 and 408 may communicate over wired or wireless link 418 as well as over network 410. Similarly, a smaller local area network 412 may be set up to allow communication between Socializer devices, such as portable device 402 and computer 406. The Socializer modules executed by either the computing devices 402 and 408 and computers 404 and 406 are peer-to-peer modules that both request and send data to the other devices on the network.

In one embodiment, the network 410 is the Internet. For this embodiment, each of the computers and computing devices are configured to access one or more World-Wide Web (WWW) servers that store and serve data in the form of web pages and written as Hypertext Markup Language (HTML) files. For this embodiment, the computers and computing devices typically run web browser programs to access the web pages served by these server computers and any available content provider or supplemental servers.

In one embodiment, the Socializer application defines a particular user's “neighborhood.” In general, a neighborhood refers to all other Socializers that a user can reach and are registered with. Registration comprises the act of mutually agreeing to participate in information and data sharing using the Socializer services and/or respective Socializer devices. The range of people within a user's neighborhood can vary depending upon the actual network implementation and registration capacity of the Socializer service or storage resources of the Socializer device used by the user. In general, the network 410 or sub-networks 412 and 418 can be large-scale (global) networks or multi-hop networks that allow the user to reach virtually anybody anywhere else in the world, such as by using portions of the global telecommunications structure.

The Socializer provides a platform for a user to build a set of contacts comprising other registered or subscribed members, elicit opinions or gather information from those members, and possibly even access data stored on other members' computers or computing devices. Data is generally entered into the Socializer device or program using appropriate data entry means. Text files, spreadsheets, lists, or database modules can be used to store contact information, textual data, identification data, opinions, and so on, while content data such as sound files, pictures, video, and so on can be stored in the appropriate format in the device or computer.

A user typically builds a social network by adding contact information for people (members) within his or her interest group—consultants or others who might be interested in sharing information or activities, and then adds content regarding the interest in the device, which can be shared by the other members. In one embodiment, a user can broadcast a query or action item, such as if anyone within his “neighborhood” would like to meet. As affirmative responses come in, the user can add the people to the Socializer contact list. Using the access tools, the user can access data held by the people in his neighborhood. In an example of use in which the Socializer device is capable of storing and playing digital music files, the Socializer can be configured to access a list of music being shared by an interest group and rank the list according to popularity among the group. The user can then listens to the most recommended music to expand his musical knowledge. In general, “content data” refers to the actual files or data directly related to the interest, such as songs, pictures, video clips, and so on, whereas “non-content data” refers to the contact information, opinions, recommendations, and so on.

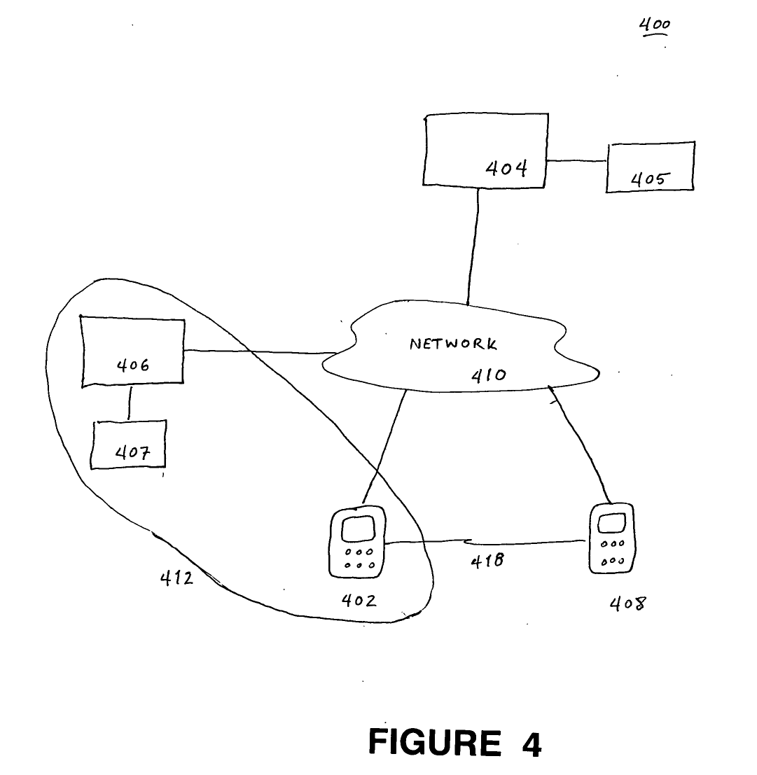

FIG. 5 illustrates the network states for a Socializer device, according to an embodiment. As shown in FIG. 5, the Socializer can be in one of three states: passive-off 502, passive-on 504, and active-on 508. The most basic state is passive-off 502. A Socializer device that is powered off, or a computer in which the Socializer software has not been started would be in this state, as would a Socializer that cannot achieve network connectivity for any reason: such as being out of range, having a broken Network Interface Card (NIC), inoperable software, and so on. When a Socializer is on and can potentially communicate with another Socializer, there is a transition to the passive-on state 504. In this state, the Socializer device can connect to another Socializer and vice versa, although currently there is no active network session from this particular Socializer. However, the Socializer will still send discovery messages that will allow other Socializers to see that this particular entity exists, and other Socializers can passively “see” this Socializer. When actively initiating a session with another Socializer, the active-on state 506 is entered. Returning to the passive-off state 502 occurs when network connectivity is lost regardless of the reason.

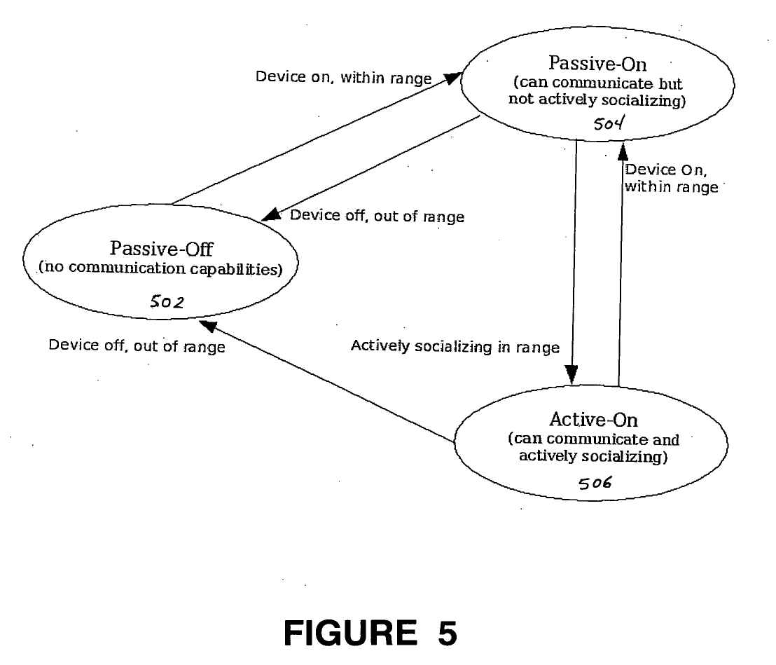

In one embodiment, the Socializer comprises four major software components: (1) an interest manager, (2) a contact manager, (3) a security panel, and (4) a content manager. FIG. 6 illustrates the main functional components of the Socializer, under an embodiment. The contact manager 602 manages the storage of non-content data within the Socializer, and allows a user to browse the content of other Socializers for people in the user's neighborhood through contact maintainer 612 and communication plug-in 614 submodules. The contact maintainer 612 serves to store the contact information for the user. Contact information is typically stored in the form of an “address book” or similar structured database. Contacts can be added for any person who the user desires to add, and once in the contact list, the contact is considered “static.” An interest group assigner is associated with each person in the contact list to distinguish entries in terms of interest group. For example, some people in an address book can be in a person's music interest group, as opposed to the person's computer interest group. Entries in the address book are also assigned a trust level. This allows different people to be allowed access to different types of level of information stored in the person's Socializer. For example, people who the person has just met can be assigned a low trust level so that they can browse a small portion of his Socializer, and not everything in the Socializer.

Once the contact information has been stored, communications plug-ins 614, such as an IM (Instant Messaging) module, can be used to send a message to other members in the interest group. A Voice over IP (VoIP) module can also be included for alternative communication, as can an alert module to send an alert to other contacts when a certain event has taken place.

Before any data sharing can begin, the Socializer must be set up to be accessed by other devices in the network. In order to share their data, such as music that might be stored on a Socializer, a user must create a music interest group in the interest manager and add the music (e.g., MP3) files to the interest group. They must also add some access control so that although anyone could browse their music collection to see what they listened to, only people they know could actually listen to their music. The sharing function is controlled by interest manager 608.

Access control and trust levels are defined in the security panel 606. Access control levels are assigned to interest groups and control what users in a given group are allowed to view. In order to override group access controls, trust levels are assigned to individuals. This allows one to specify that a close friend have more permissions than normal. Bias levels are also assigned for each person in the address book. The bias reflects how much one values the contact's opinion in this particular subject.

Access control in current peer-to-peer (P2P) networks is limited. In most cases, everybody has the ability to read all the files being shared. At best, some systems allow one to limit the scope of the network, but even then, read access is given to all members of the network. In one embodiment, the Socializer uses trust weighted peer-to-peer access control. A given interest group, along with its associated files, has a default access control. However, a user can create a contact for someone along with a trust level, overriding the default access control. The user then has the ability to limit access rights as he or she sees fit.

In general, current peer-to-peer networks do not treat all nodes equally, either in the control sense or the data sense; all require some sort of centralized directory service or have a limited set of distributed super-nodes that control the directory. The Socializer described herein does not require a centralized or hierarchical directory service of any sort, for either control or data. Instead each Socializer implements a “flat” directory service to perform node registration. When a node becomes available, it registers itself with the other nodes. The other nodes either check the directory service or are notified by the directory service when interested nodes come online.

In one embodiment, Socializer entities are dynamically discovered in the vicinity, with the vicinity defining the user's “neighborhood.” Entity discovery is accomplished by a proactive routing protocol. Additionally, the entity notification proactive messages can be used to communicate interest and bias information (and other non-content data), which can be used instantly to guide the user to preferred (via bias or interest matching) Socializer users in the network. Each Socializer is responsible for sending notifications when it joins a network and periodically sends updates. In order to limit the size of the discovered network, notifications can have a hop count limit, i.e., limiting the radius of the network centered around the user's Socializer. To find data in a peer-to-peer network, a search is usually run against a directory listing. The results will include nodes that have the desired data. The paradigm is that data is distributed throughout the network and the user is looking for specific data. In one embodiment, certain metadata, such as trust, bias, opinion information and the like are stored in local Socializers so that historical data regarding members' opinions, access privileges, and so on are available for browsing.

The implementation of browsing functionality allows members of a social network to access each other's devices or computer resources and find content or information relating to the interest. As illustrated in FIG. 6, several browsing functions are provided by the different functional components of the Socializer. In general, the data manager 622 of the content manager 604 allows a user to see his own raw content. These can be the actual documents, files or objects comprising his stored content data, and can be arranged in any file or directory structure utilized by the device or user's computer system. The interest manager 608 contains a process that allows a member to browse content based on particular interests on any Socializer within a network. Using the interest manager, a member might search for content data based on in interest or sub-interest within one or more interest groups that he may be a part of. The contact maintainer 612 of contact manager 602 allows point-to-point browsing where a member can browse for content data on a specific user's Socializer. In general, accesses provided by browsing members to content data on a user's Socializer are controlled by the access privileges based on the trust between the members and the user. The content data viewed and accessed by the members on a user's Socializer may be represented as the raw data in a native directory structure, but more commonly, it is represented as generic data objects that are not represented in any specific format or directory structure.

In certain implementations, the goal of the Socializer network is not simple file sharing, but socializing. The paradigm is of finding new people and sharing interests, not just files. As such, in a standard implementation, there is no centralized directory listing of files. A search can be run, but it will run on the individual Socializers. When people share interests (via metadata or content pertaining to that interest), the recommendation given is implicit: I like this and recommend that you try it. The value one assigns to the recommendation (e.g., this person has made great recommendations in the past so I should listen to her) must be tracked separately, either by explicitly noting the fact somewhere physically, or more likely, by simply trying to remember.

To automate the recommendation concept, the Socializer includes a recommendation system that ranks the opinions as weighted by the bias assigned so that the more knowledgeable or valuable opinions carry more weight than less knowledgeable or less valuable ones. Opinions may take on relative values such as excellent, good, bad and atrocious, while bias may take on values such as complete, some, and none. If the user prefers, a numeric system may be used instead. Other ways of receiving recommendations is simply by asking or transmitting queries to other users in the system.

The Socializer allows voting, again weighted by the bias. For tracking a single index, opinions presented via messages or tagged to content in others' Socializers, are bias weighted, and the resulting index is called the recommendation.

The content manager 604 includes a data manager 622 and a plug-in manager 624 that provide the basic functions associated with searching information and data stored on other Socializers within a user's network. Based on attributes derived by user queries, input or interest group specification, the data manager 622 performs the appropriate searching, filtering, and browsing steps to locate and import the data to the user's Socializer device. The Content Manager represents a significant portion of the Socializer, since it provides the ability to share data within a social network.

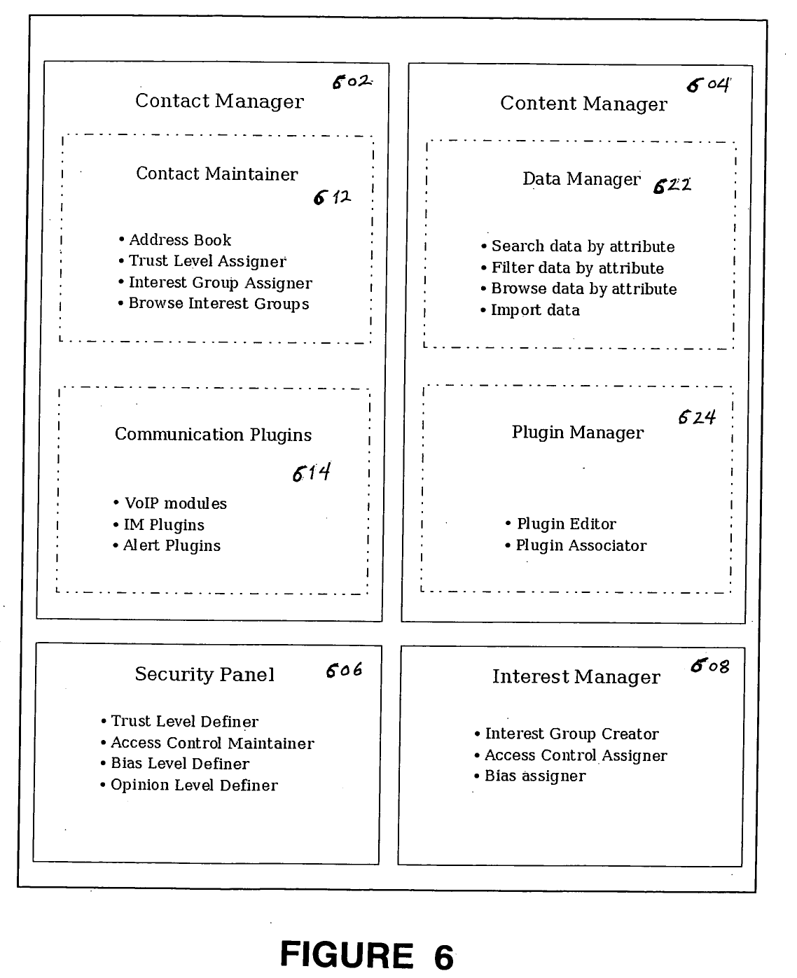

FIG. 7 is a diagram that illustrates the functional components and process flows for the content manager of the Socializer, under an embodiment. The content manager 702 controls sub-processes that import data 704, perform searches 706, browse content 708, and manage plug-in programs 710. Data is usually generated external to the Socializer and imported into the Socializer using the data import process 704. For example, photos created by a digital camera, music recorded through a mixer, web pages downloaded from the Internet, and so on. Data can be imported into the Socializer from network resources, other computers, and other Socializers as long as the data owners and copyright owners are willing. If Digital Rights Management (DRM) is enabled for certain content, the Socializer can be configured to not allow importation of such content from other Socializers. In some cases, this media may be accessed ephemerally. For instance, music can be streamed so that the Socializer can operate as a content broadcaster (e.g., radio station) rather than as a storage device.

As opposed to the more common directory structure for storing data in the form of files, the Socializer stores files (to the user's view) in interest groups. This facilitates the sharing of relevant data to interested people, and eliminates the need to have these people navigate a hard to read directory tree on the Socializer device. Thus, the imported data is stored on the Socializer through the interest group structure, and accessed by another user who selects the remote directory and interest group, 712.

In order to make managing the data easier for a user in a network that can potentially have hundreds of gigabytes of data, the content manager has built-in filter, browse and search capability 706. A user can browse and search based on file type, filename, keywords, and meta-data. The browse function also spans other Socializers. Since there is no directory listing outside of the Socializer itself, a given Socializer can request that others perform a search and return the results.

In order to view the data properly, program plug-ins are typically needed for the Socializer device. This facilitates downloading of the latest programs to allow accessing, viewing or seeing new content. For example, photos may need to be viewed with a JPEG viewer, and music played with an MP3 player, which may not be resident in the Socializer device. Just as data is downloaded to the Socializer, plug-ins can be downloaded 728, or updated 726 with a new version using the plug-in editor 718 within the plug-in manager 710. The plug-in manager contains sub-processes that allow available plug ins to be listed 722. Plug-ins that are not needed or wanted can be deleted 724. The association manager 720 portion of the plug-in manager 710 allows the Socializer to invoke the proper content aware application when viewing data. This is accomplished by associating a file type/file extension with a plug-in 732. The plug-in file types for this association manager can be listed by process 730.

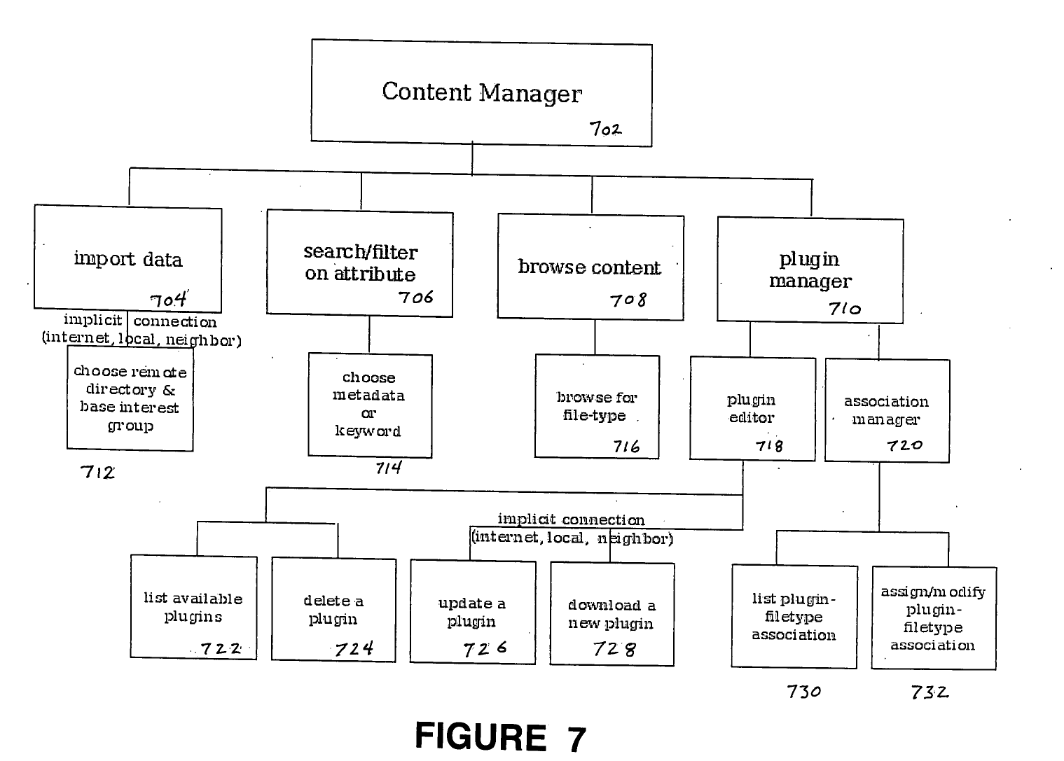

In one embodiment of the Socializer, data is grouped by interest groups, which are controlled by the Interest Manager. FIG. 8 illustrates a flow process for the interest manager portion of the Socializer under an embodiment. The interest manager module 802 allows interest groups to be added, edited, and deleted 804. It also allows bias values to be assigned to members 808. In addition to one's own groups, it is possible to browse the interest groups of other Socializers that are within range, 810. Some groups may be pre-defined, but the rest can be specified by the user. Each interest group is individually assigned a base access control level 804. Each file imported is assigned this base level if imported into this interest group. The four default levels are read, browse, deny, and write. Read allows anyone to read/view the file while browse allows anyone to see that the file exists and the name, but not be able to read or view the file. This allows others to see what a users interests are in more detail. For example, if a user has a nature interest group with many JPEG files named Yosemite Park, this lets others know that the user is not just interested in nature, but in Yosemite in particular. Deny does not allow anyone to read or even know that such files exist on the Socializer.

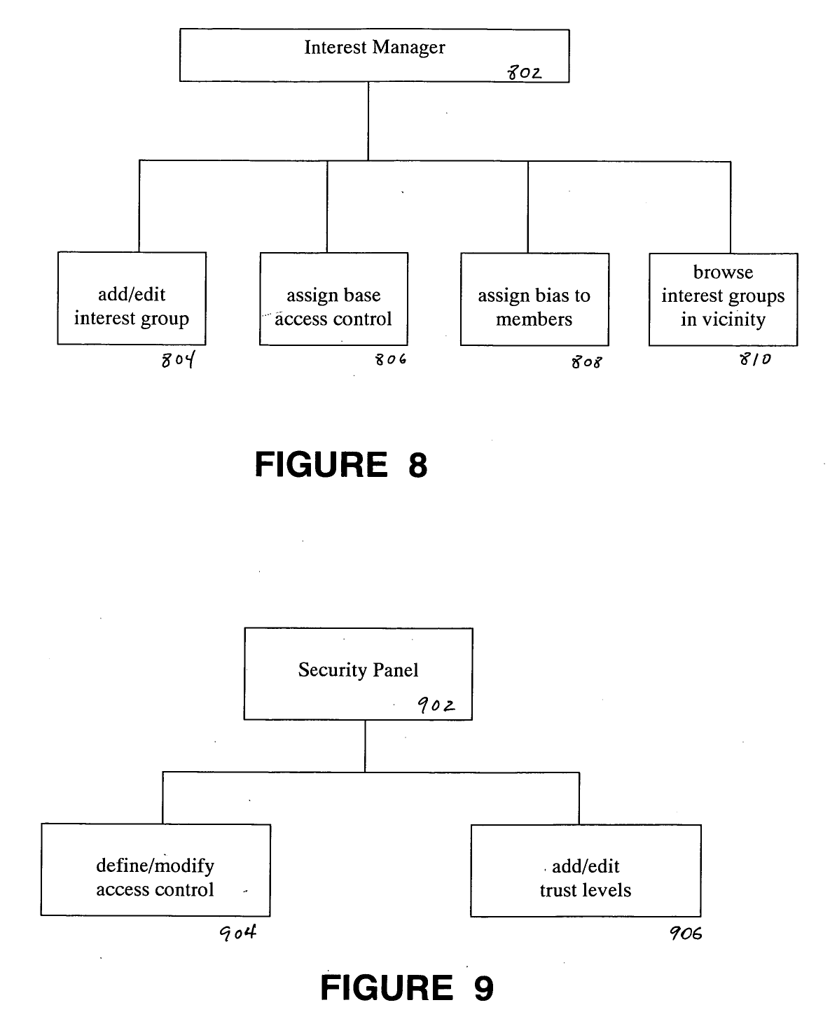

The base access control level 806 only applies to other members browsing a user's Socializer and who are not a member of the interest group. Members are added through the contact manager. As a member, different permissions apply. A member's access level is a combination of his/her trust level combined with the base access level. The three base trust levels are ultimate, medium, and low. The access function is controlled by the security panel. FIG. 9 illustrates a flow process for the security panel under an embodiment. Process 902 allows a user to define and modify access control for members, and process 904 allows the user to add/edit the trust level for the members. Ultimate trust allows a member to read all files belonging to the interest group, ignoring the base access level. Low trust is the opposite, where access is entirely controlled by the base access level. Medium trust allows one to read files that are marked as read or browse, but files that are marked deny are still not accessible. Should the base access levels and base trust levels not be granular enough, the security panel 902 allows the user to define additional access controls and trust levels, along with additional levels for bias and opinion.

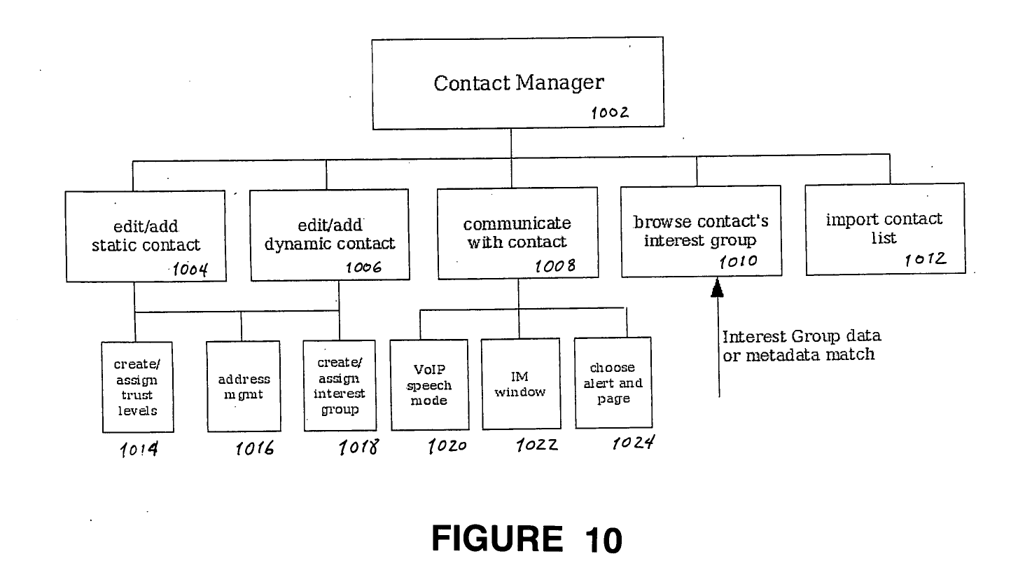

The Socializer includes a contact manager that allows a user to add and manage the many people who might comprise the user's social network. FIG. 10 is a diagram that illustrates the functional components and process flows for the contact manager under an embodiment. The contact manager represents the aggregate person view of the user's social networks. Everyone in the social network has a contact entry in at least one other members' Socializer. The basic way to create a contact is to add one manually using the edit/add static contact 1004 or edit/add dynamic contact 1006 subprocesses. In addition to the usual information contained in an address book 1016, each contact has two key pieces of information associated with it: trust level 1014 and interest groups 1018.

When adding a contact to an interest group, in addition to assigning a trust level 1014, the user can assign a bias level. The bias level indicates how much the user values the opinions of the added contact in the given interest group, and hence may take on values such as complete, some and none. The bias is used when the contact is allowed to give an opinion on file content on the user's Socializer, such as, for example, if the user asks “what does everyone think of this picture I took?” When importing or browsing data from other Socializers, the contact's bias will be part of the file's meta-data so that the user can sort based on recommendation (which is opinion weighted by bias). The bias is also tagged to all messages that are received by the user through communication subprocess 1008, including voice 1020, IM 1022, emails and alerts 1024.

One of key aspects of social networking is the ability to meet others through one's direct contacts, i.e., members with an Erdos number of one. Therefore it is also possible to import a group of contacts that you initially knew through a third party through the import contact list subprocess 1012, thereby decreasing the Erdos number for that group of people. However, a third party is not always necessary. Through the Socializer's networking capabilities, it is possible to meet a random person based on network connectivity. Such a person would be a dynamic contact. Dynamic contacts are valid only as long as network connectivity is maintained between the user and the contact. To make a permanent contact, the dynamic contact must be converted to a static contact. Dynamic contacts typically garner more curiosity if there is a match between the Socializer user's interest group(s) and the dynamic contact's interest group(s). This “match” may not be an exact match on any content within the interest group, but may instead be a match on metadata for the interest group. This interest matching is the key to socializing further, and leads to a browsing of the dynamic contact's interest groups through the browsing process 1010, gathering influences, opinions and recommendations, communicating with the dynamic contact and maybe even make that contact a static contact; and finally using this information to make decisions.

In general, interest groups are the commonalities between a user and his or her contacts. The Socializer allows the user to not only share the fact that he or she has common interests, but also share data regarding those interests. An example might be the Yosemite photos that a user wants others in the nature interest group to be able to see using their Socializers. By browsing a contact's interest group, the user can see what hobbies are shared and within an interest, see what information is shared. As the Socializer is not simply a passive data storage device, but a communications tool as well, it is possible to communicate with a contact using the communications subprocess 1008. When looking at a contact (dynamic or static), there are options to make a call, send an instant or email message (including text and/or data), or send an alert/page, through subprocesses 1020 to 1024.

The Socializer can be implemented in device form as an application running on either a mobile computing device, such as a Personal Digital Assistant (PDA) class device or a computer, and as such, certain modes of operation are required to support all the social networking concepts described herein. In one embodiment, the Socializer implements specific routing software to implement the communication, contact and content management functions. The routing software is proactive, and in the case of ad-hoc wireless operation, it supports ad-hoc mode. The proactive nature of the routing code supports two critical functions to accommodate attachment of new Socializers to a network, and entity discovery. In general, when a new Socializer entity attaches to the network, the new entity must send a message to alert others that it has joined. Proactive routing gives the Socializer the ability to perform entity discovery. Most entity discovery protocols are limited to small network sizes; with proactive routing, the network size can be much larger. With discovery, the user can then browse the network when new people join the network. Without discovery, in order to browse someone's Socializer, a priori information, such as the IP (Internet Protocol) address, would be necessary.

In addition, the proactive protocol is used to transmit bias and interest group information right at the moment when an entity joins the network. Using this information the Socializer can perform interest group matching (like matching the artists or albums or genres of music), and even filter or sort the viewable Socializers on the basis of bias. In an alternative embodiment, the routing protocol includes a hybrid routing protocol consisting of both proactive and reactive processes.

In ad-hoc wireless mode, the routing software allows networks to be built without infrastructure support, namely access points. Using ad-hoc routing, one Socializer is able to communicate with another simply by using other Socializers as intermediate routers (multi-hop networking). This can result in significant cost savings for use, as connected WiFi hotspots are no longer needed. Additionally, this multi-hop wireless ad-hoc mode relaxes the constraint that nodes have to be in the geographical vicinity of each other to be able to socialize.

This pro-active control and data plane functionality can be achieved by implementing a modified and enhanced variant of a proactive ad-hoc wireless routing protocol, such as Direct Sequence Distance Vector (DSDV). In one embodiment, certain enhancements to support this pro-active control and data plane include the following. The protocol is adapted to run over an IPv6 as well as an IPv4 network. The initial few packets are modified to include interest group and/or bias information, which may be used in interest matching algorithms on each Socializer, as well as to provide bias weighted access to the social network. The protocol is enhanced to be able to run over a wired or organized wireless network by removing the restrictions placed by the assumption of an underlying ad-hoc wireless network.

In general, pro-active protocols do not scale well. Modifications are therefore made to improve scalability. For example, restrictions may be placed on hop count and other metrics to help the protocol stay focused. To fine-tune these restrictions, there may be limitations placed on the transmission of bandwidth intense data (such as streaming audio or video data) to fewer hops, while transmission of bandwidth un-intense data (such as interest group metadata) may be allowed to route across more hops. Hence interest matching could be done over a greater range (more hops), thus leading to better social visibility. The protocol can also be modified to become a hybrid routing protocol when a significant number of Socializers are in the network, such that proactive join notifications are still sent, but routes are cached and the protocol moves into reactive mode for longer periods of time, until the cached routes are aged out via an aging heuristic. This will allow the routing and control plane of the Socializer to scale well.

In one embodiment, the networking stack of the Socializer system supports IPv6 as well as IPv4. The key IPv6 features are network auto-configuration and a large address space. As the Socializer may be embodied as a consumer tool, it is desirable to not require the user to configure the tool from a networking point of view. Once turned on, the Socializer is configured to automatically connect to the network and begin functioning. Quality of Service (QoS) features will also be used to ensure that the real-time communications and media/data streaming work without interruption. To implement the necessary security functionality (necessary for a networked tool) the IPSEC features will be used in certain areas for authentication, authorization, and encryption.

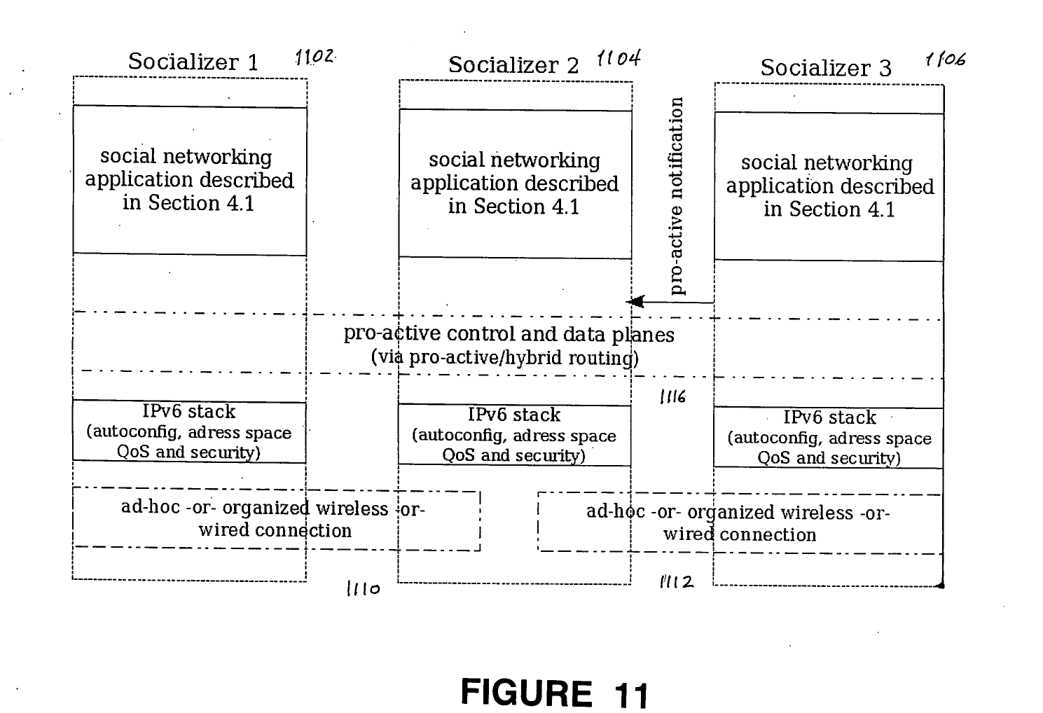

FIG. 11 illustrates network components for networked Socializer devices, under an embodiment. As shown in FIG. 11, three separate Socializer devices 1102, 1104, and 1106 are coupled to one another over one or more ad-hoc or organized wired or wireless connections 1110 and 1112. Each Socializer device contains the social networking applications that allow the users to find members, add contacts, share content, elicit opinions, and so on, as described above. Each also includes the IPv6 stack that provides autoconfiguration, address space, QoS, and security functions, and the pro-active control and data planes 1116.

For embodiments in which the Socializer is a software program running on a networked computer or workstation, the IPv6 stack may or may not be necessary. As most computers configured to connect to the Internet already, the main desired features, auto-configuration and a large address space, may no longer be necessary in this environment. The Socializer in this case can simply use the computer's current networking stack. On the other hand, depending upon the personal network setup for the user, it may be necessary to include the IPv6 stack to uniquely identify the Socializer computer.

In one embodiment, and for ease of use, the Socializer also incorporates a Graphical User Interface (GUI), which supports multimedia use. For the hardware incarnation of the Socializer, the GUI is also configured to support some type of handwriting recognition (for data entry). In this case, a backup visual keyboard on the screen is also available.

For the embodiment in which the Socializer is embodied within a device itself, the Socializer device may be based on or modeled after present PDA devices, such as the Palm® Tungsten™ or similar devices, such as multimedia players (e.g., MP3 players), game players, and communication devices. The PDA device based Socializer includes a color touch screen and audio output, as well as a built in keyboard or GUI based keyboard. To store all of the user's media/data files as well as contact information, a mass storage device, either flash memory or a hard drive, is needed. Additionally, a Universal Serial Bus (USB) connector may be required provide external interface capability, such as communicating with the wired or wireless network via the connected computer, and/or to synchronize data and metadata with the connected computer. Given that a key characteristic of the Socializer is its mobility and dynamic social networkability, it is also configured to include a WiFi interface. This interface can also include a ZigBee (IEEE 802.15.4) and Radio Frequency Identifier (RFID) interface. To accommodate extra hardware for new applications, at least one expansion slot should be available. Modules such as digital cameras and GPS receivers can then be added.

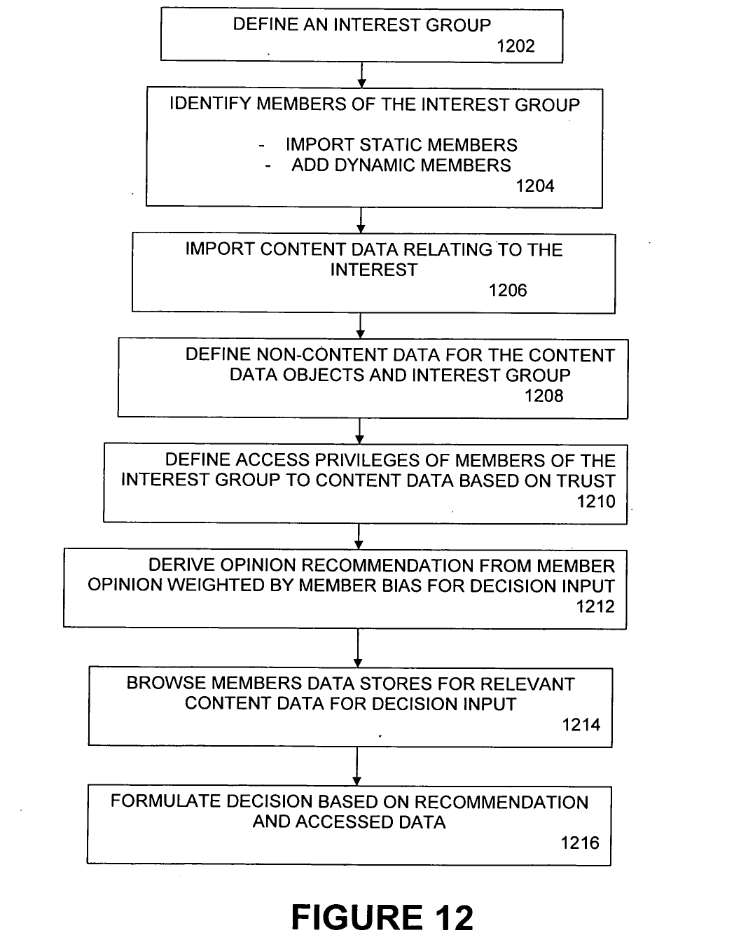

FIG. 12 is a flowchart that illustrates a method of defining a social network and formulating a decision based on the social network, according to an embodiment. In step 1202, an interest group is defined. This might involve a user forming his own interest group based on a specific interest he has and inviting acquaintances to subscribe to a network through the use of Socializer devices, or finding and joining an existing interest group. Once an interest group is defined, the members of the group are identified, 1204. Static members, who are long term acquaintances can be imported or entered into a static database (address book) and temporary or dynamic members can be added to the same or different database. The content relating to the interest is imported or loaded onto the Socializer device of the user or members of the interest group, step 1206. Typically this comprises the data objects for the subject matter of the interest, such as songs for a music interest group, or photos and blueprints for an architectural interest group, and so on. Once the content data is defined, the non-content data for the interest group and data is defined, 1208. This typically comprises the meta-data for the content objects and identity and other information for the user and interest group members, and information regarding the interest.

In step 1210, the access privileges of the members to the content data stored on each members' Socializer are defined. This is based on the trust measures and dictate whether and how much browsing capability and access each member has to the other members' content data. When a user formulates a query for a decision to be made or an action to be taken, he can elicit response from the other members or access their data to formulate a decision. In step 1212, the user obtains and derives recommendations from the members. The recommendations comprise the members' opinions weighted by their respective biases. If multiple recommendations are received, the user can compile the recommendations to derive an overall recommendation. In some cases, the user can browse other members' content to obtain samples or similar content data, step 1214. Based on any received recommendations or accessed data, the user can then formulate the decision, 1216.

Aspects of the social networking device and process described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the Socializer include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the Socializer device and methodology is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the business automation system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the social networking system are presented below in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A device comprising:
a communications interface for communicating with one or more peer devices over a network;
a data store for storing data relevant to an interest of a user of the device and identification information for respective users of the one or more peer devices; and
a content manager circuit configured to store data on the device based on the interest of the user and browse content stored on the one or more peer devices.

2. The device of claim 1, further comprising an interest manager circuit configured to group the respective users into one or more interest groups and assign access rights to the respective users of the one or more peer devices.

3. The device of claim 1, wherein the network comprises one of a wired network and a wireless network.

4. The device of claim 3 wherein the network comprises one of a single-hop network and a multi-hop network.

5. The device of claim 1 further comprising a protocol manager configured to implement pro-active routing enabling the device to discover one or more peer devices as they attach to the network.

6. The device of claim 1, further comprising one or more browsing processes configured to allow the user to browse the user's own content or any other content based on the interest associated with the content or the identity of the owner of the content.

7. The device of claim 6, wherein non-content data comprises opinion and bias data of the users of the peer devices with respect to the content data, and wherein the content data comprises at least one of text, images, and sound files representing data objects for the data relevant to the interest of the user.

8. The device of claim 7, wherein the peer devices comprise personal digital assistant class devices coupled to the network.

9. The device of claim 7, wherein the peer devices comprise personal computer class devices executing one or more software modules for performing social network interactivity functions.

10. A device for building a social network for interactivity of members within an interest group comprising:
a contact manager component for storing identification information related to the members of interest group;
a data manager component for loading and storing content data related to an interest of the interest group;
a security component for defining access privileges for the members relative to a user of the device, and bias information for the members with respect to the interest of the interest group; and
a communication interface allowing the user to browse content data held by respective devices operated by the members of the interest group.

11. The device of claim 10, wherein the content data is stored in the form of data objects representing aspects of the interest.

12. The device of claim 11 wherein the data objects are associated with one or more metadata descriptors providing identification information regarding data type, accessibility, and interest group.

13. The device of claim 12, wherein the data manager is configured to provide access to the content data on each respective device through information contained in the metadata descriptors.

14. The device of claim 12, wherein the data objects represent multimedia data content capable of being played by playback modules on each respective device.

15. The device of claim 14, further comprising a plug-in component for finding and downloading an appropriate playback module to the device from an external resource.

16. The device of claim 15, wherein the data object comprises one of a song, a picture, and a video stream.

17. The device of claim 12, wherein each respective device comprises one of a music playback device, a game playing device, a network communications device, and a personal digital assistant device.

18. The device of claim 10, further comprising a network connectivity circuit for maintaining the device in one of three states of passive off, passive on, and active on, while the device is coupled to the network.
